(19) United States
(12) Patent Application Publication
(10) Pub. No.: US 2008/0087070 A1
(43) Pub. Date: Apr. 17, 2008

(54) Gas-energy observatory with Wobbe-index

(76) Inventors: Mauritius H.P.M. van Putten, Cambridge, MA (US); Anton F.P. van Putten, Eindhoven (NL); Michael J.A.M. van Putten, Enschede (NL); Pascal F.A.M. van Putten, Delft (NL)

Correspondence Address: MAURICE H.P.M. VAN PUTTEN, 266 PEARL STREET A, CAMBRIDGE, MA, 02139, US

(21) Appl. No.: 11/546,230

(22) Filed: Oct. 12, 2006

(51) Int. Cl. G01N 7/00

(52) U.S. Cl. 73/23.2

(57) ABSTRACT

We recently disclosed a novel observatory which captures the complete picture in domestic gas-energy usage and local weather data in real-time. It uses a new principle of thermodynamic anemometry, wherein a fraction of the flow is extracted and passed through a small measurement chamber. Here, the external flow modulates heat-transport amplified by buoynancy-convection, and the induced Nusselt number is a measure for the Reynolds number of the flow. Based on an effective viscosity amplified by convection-buyoancy, the resulting mass-flow measurements are inherently insensitive to variations in temperature and pressure. In the application to natural gas metering, gas-composition may vary with commensurate impact on mass-flow metering and energy-metering. In mass-flow metering, sensitivity to gas-composition is mediated by the effective viscosity. In energy metering, the interchangeability of various gas-compositions is well-described by the Wobbe-index. For example, these sensitivities are, respectively, 0.65% and −1.3% per percentage of nitrogen concentration. Here, we disclose a dimensional reduction in thermodynamic anemometry in the form of the molar concentration ratio of nitrogen to the combined concentrations of hydrocarbon elements. We find that the effective viscosity and the Wobbe-index can both be accurately parametrized by the concentration of nitrogen, irrespective of the mutual concentration levels of the hydrocarbon compounds. Detection of nitrogen concentration is conveniently performed by measuring the effective thermal conductivity, on the basis of the total power dissipation in the sensor. The combination of mass-flow and Wobbe-index benefit customers and gas-suppliers.

### BACKGROUND OF THE INVENTION

High-standards for home energy efficiency in new and existing buildings are key to meeting the Kyoto Protocol on reducing greenhouse gas. Its goal is to reduce emissions by 5.2% relative to the 1990 level in the upcoming period 2008-2012. Information technology will be the starting point to any cognitive ergonomic intervention by exploting novel measurement techniques, data-analysis and validation. It further invites the shaping of public policy, to ensuring open consumer markets in energy measurement and information technologies. Understanding the human factor in using advanced energy information, based on forecasts on costs, cost-savings and the climate impact by greenhouse emissions, will be key to the successful introduction of energy saving strategies.

We recently performed an experiment on new energy-weather data on residential gas-consumption (van Putten et al. 2006). We disclosed a novel observatory for visualization of real-time gas-energy usage in its relation to local weather conditions. It acts as a “digital camera” which capture the complete picture of domestic gas-energy usage with a resolution of once per 2.5 seconds. It reveals a partition of gas-energy usage used in residential facilities and heating. By increasing public awareness in energy consumption at home, it enables informed decisions on saving energy strategies with regards to using residential facilities, home-climate settings and home improvements.

The observatory also creates financial-energy data to gas-suppliers in electronic form. It facilitates automatic meter reading (AMR) through electronic or wireless interfacing to a telecommunications network, real-time detection of peak-flow usage, and automatic billing. Ideally, customers are billed for on the basis of mass-flow corrected for variations in the Wobbe-index. Natural gas composition is known to vary from source to source. Gas-suppliers may choose to control the gas-composition so as to maintain a constant Wobbe-index, or correct for the Wobbe-index at the time of billing. The Wobbe-index is the industry standard for the interchangeability of natural gas in injector powered appliances.

For natural gas, the Wobbe-index is defined according to the gross caloric value divided by the square root of the relative density of the gas. Therefore, the Wobbe-index is distinct from the caloric value of natural gas. The caloric value in the hydrocarbon compounds CₙHₘ of length n with m-hydrogen atoms (where m=2n+2 for most lower-order compounds) varies close to linearly with n. The Wobbe-index shows a totally different trend. Because the density of the carbon-chains is close to proportional in n, the Wobbe-index is approximately proportional to \sqrt{n} for the pure compounds CₙHₘ. In particular, consider Table I for common lower-order compounds and natural gas:

TABLE I
Wobbe-index and caloric value of some common fuels in MJ per nm³.

| | | | | Natural |
|---|---|---|---|---|
| | | | | gas |
| | methane(CH₄) | ethane(C₂H₆) | propane(C₃H₄) | (Gronings) |
| Wobbe- | 53.4 | 68.6 | 81.1 | 43.7 |
| index: | | | | |
| Net | 35.9 | 64.4 | 93.2 | 31.7 |
| caloric | | | | |
| value: | | | | |

In this disclosure, we shall focus on determining mass-flow and Wobbe-index in metering with in-situ corrections for variations in gas-composition. For example, the primary components of Gronings natural gas are, in molar concentration levels, 81.29% methane and 14.35% nitrogen (Nederlandse Gas Unie 1988), while the average values of the same in the US are 92.3% methane and 1.8% nitrogen (Liss & Rue 2005). Different types of natural gases have been introduced, according to their Wobbe-index: Group L:=[39.1,44.8], Group H:=[45.7,54.7] and Group E:=[40.9,54.7] in units of MJ/m³ (Marcogaz 2002). L and H qualities, for example, use non-interchangeable gas-distribution networks (Foss 2004). The L-type Gronings natural gas and the H-type US average serve to illustrate that natural gas is to leading order a binary mixture of methane and nitrogen (their concentration levels may vary, but with on-average constant sum of about 95%).

In the application to residential natural gas-consumption, we discuss a multi-faced observatory for gas-energy usage and local weather, serving customer, the gas-supplier and climate researchers. The observatory serves the customer with a visual representation of the complete picture of gas-energy usage in relation to local weather data, with applications to energy-saving home-climate systems and energy audits; the gas-supplier with total normal volume, peak-flow and Wobbe-index; and the government by integration into a wide area climate observation system for public use.

The observatory uses the measurement principle of thermodynamic anemometry of van Putten et al. (2006). We here disclose the background and application of two sensor-signals in thermodynamic anemometry, representing mass-flow and an effective thermal conductivity for the purpose of
measuring the concentration of nitrogen relative to the combined concentration levels of the hydrocarbon compounds
correcting finite sensitivity in mass-flow to gas-composition
monitoring the Wobbe-index.

We begin with a summary of the disclosure, including a summary on thermodynamic anemometry. We descibe a method for measuring the Wobbe-index, a summary of the experimental results and a preferred embodiment. We close with some claims.

### SUMMARY OF THE DISCLOSURE

Thermodynamic anemometry is a new measurement principle for fluid flow. It features some novel properties with regards to measuring mass-flow, which puts it apart from existing measurement princples. It operates by passing an external, periodically modulated flow interacting with buoyancy-convection in a micro-chamber. It measures mass-flow by the induced Nusselt number on a heated silicon chip.

Buoyancy-convection is characterized by the ratio of buoyancy-to-viscous forces, characterized by the Rayleigh number, Ra. The Rayleigh number is expressed by the product of the Grashof number Gr and the Prandtl number Pr. Here, the Grashof numer satisfies

$$Gr = \frac{g β {L}^{3}}{{v}^{2}} , \qquad ( 1 )$$

where g the gravitational acceleration, β=ΔT/T the temperature elevation ΔT of the chip relative to the temperature T of the aluminum chamber with length scale L, and v the kinematic viscosity. The Prandtl number Pr of a fluid expresses the ratio of diffusions coefficients of heat and momentum. In the gas phase, we have Pr=0.7-0.8, so that the Rayleigh number Ra=Pr Gr is, in most cases, similar to Gr up to a constant factor of order one. For a micro-chamber with vertical dimension L=0.3 cm and a chip temperature of 100 degrees Celsius, the Grashof number of various calibration fluids spans a wide range of values:

Gr[Ar]=323, Gr[CO₂]=890, Gr[N₂]=252, Gr[He]=4.09. (2)

Buoyancy tends to significantly modify heat-transport by convection. As discussed below, the result can be seen in enhanced transport coefficients. In our measurement chamber, the configuration is somewhat similar but more complicated than a standard Rayleigh-Bénard configuration (Rayleigh 1916, Chandrasekhar 1961), given that the bottom surface is only partially heated by a small silicon chip. The resulting horizontal temperature and density gradients hereby render the fluid unstable at all Rayleigh numbers, also below the Rayleigh-Bénard criterion Ra>Ra_{c}≃1700.

An externally applied flow passing through the micro-chamber breaks symmetry in buoyancy-convection cells surrounding the chip. Asymmetries create non-uniform heat-transport to the fluid, and a corresponding non-uniform temperature distribution in the chip. The temperature distribution can can be picked up by a Wheatstone bridge integrated on the chip (van Putten & Middelhoek 1974), here modified to parallel topology at opposing edges for bi-directional sensitivity. The Wheatstone bridge consists of temperature sensitive resistors, allowing in-situ measurements of small temperature gradients in terms of an electrical output signal. To maximize sensitivity, we use a modulation technique in the form of the Alternating Direction Method (van Putten et al. 1995, 2002). It appliess external flow to the micro-chamber in subsequently opposite directions. Each measurement consists of subtracting two successive measurements, associated with opposite directions of the applied flow. The result shows a dramatic increase in sensivity by several orders of magnitude, by eliminating additive drift associated with a variety of imperfections in chip manufacturing, mounting, temperature drift and orientation effects. The modulation frequency is sufficiently low, on the order of seconds, to ensure thermal equilibration in each of the two fluid-states. The resolution thus obtained detects micro-Kelving temperature variations in the chip.

To identify scaling laws with respect to characteristic fluid dynamical quantities, we normalize the output to a dimensionless Nusselt number. For experimental convenience, we here define a Nusselt number to represent the ratio of non-uniform heat-flux δP relative to the instantaneous total heat-flux P (van Putten et al. 2006)

$$Nu = \frac{δ P}{P} . \qquad ( 3 )$$

Note a slight departure from the standard definition of a Nusselt number, wherein normalization is relative to the heat-flux by conduction alone. As a dimensionless number, the functional dependence of Nu on mass-flow passing through the chamber must be a function of the Reynolds number Re*. Here, Re* is associated with the effective momentum-transport enhanced by buoyancy, and to the same degree as the enhancement of heat-flux. In our configuration, we thus find a response curve for thermodynamic anemometry (van Putten 2006)

Nu=Nu(Re*). (4)

The distinction between (3) and the standard definition of a Nusselt number becomes apparent at large Reynolds numbers, where (4) becomes asymptotically flat by due to an increasing total dissipation. For low Reynolds numbers, (4) and the standard definition agree, and the response curve becomes linear in Re* due to the application of ADM. Linearity about the origin is a departure from the well-known King's law for hot-wire anemometry, which predicts a square-root behavior (King 1914).

The scaling relationship (4) can be tested by measuring the Nusselt response curve for the different calibration fluids Ar, CO₂, N₂ and He. To this end, we introduce the effective transport coefficients of viscosity and thermal conductivity

μ*=Gr^{1/8}μ, λ*=Gr^{1/8}λ, (5)

where the exponent 1/8 is determined experimentally by matching the different response curves for Nusselt number and total dissipation in the chip. FIG. 1 shows the resulting Nusselt-response curves. We note that the resulting scaling (4) holds well, albeit somewhat less for CO₂. According to (5), the micro-chamber has become Grashof-controlled flow-resistor, where the Grashof number is controlled by the applied electrical dissipation in the chip. For example, switching the chip on and off would modulate the flow-resistance of the micro-chamber, similar to an electrical mono-polar transistor such as a FET, with the distinct feature here of operating between two distinct physical domains.

Carbon dioxide features some interesting differences with Ar, N₂ and He. It has the highest Grashof number (2), a high melting point of 217K, low polytropic index γ=1.31, and large logarithmic temperature dependence κ=−TPr⁻¹∂Pr/∂T=0.14 about a relatively high Prandtl number of about 0.765 at room temperature. (The other fluids have, respectively, Pr=0.667, 0.721, 0.664 and κ=0.004, 0.003, 0.007.) Possibly, the high Grashof number introduces a convection-cell pattern more complicated than that in the other fluids. Furthermore, the Boussinesq approximation (Boussinesq 1897), which is believed to hold well for fluids with low melting points and small κ, may fail for fluids with large κ (e.g. Busse 1967). While of great interest to theory and experiments on pattern formation, (e.g., Bodenschatz et al. 1991), we note that CO₂ is a flue gas at rather low concentration levels of less than 1% in (Gronings) natural gas (Nederlandse GasUnie 1988). The primary components of natural gas are methane and nitrogen, both with relatively low melting points and correspondingly small values of κ at room temperatures. Extensions to (4) to accurately include CO₂, therefore, fall outside the scope of the present discussion.

The scaling relationship (4) predicts that sensitivity in mass-flow measurements to temperature variations is mediated by the temperature dependence of μ*. To test this, we performed a low-temperature experiment with He. Working with He has the advantage of having a small thermal time-constant τ[He]=0.63 (L/cm) s for a cube of linear size L, where L refers to the characteristic diameter of pipes used in our experiments. The thermal time-constants of the latter are (e.g. NIST online data base) are an order of magnitude larger, i.e., τ[Ar]=4.2, τ[CO₂]=11.6 and τ[N₂]=5.4 in units of (L/cm) s. To this end, we use a closed loop windtunnel, wherein the device is positioned in a freezer, connected with two heat-exchangers to the tunnel and its reference meter at reference operating conditions. The heat-exchangers consist of 50 cm copper pipes, and hence are limited in their heat-exchange power. Nevertheless, the results show a remarkably small temperature sensitivity in the Nusselt response curve, which agrees well with the small temperature sensitivity of less than 0.1% K⁻¹ around 300 K of the effective viscosity μ*.

The experimental results show that thermodynamic anemometry is ideally suited for mass-flow measurements of natural gas, in view of its insensitivity to temperature and pressure variations, where the latter is a well-know property of all thermal flow-measurment principles.

Three remarkably properties have been discovered in thermodynamic anemometry.

First Property. While the viscosity of natural gas components are quite different, i.e., μ[methane]=10.2, μ[ethane]=8.5 and μ[propane]=7.6 in units of μPa s, the effective viscosities assume exceptionally similar values around 27 μPa s as shown in FIG. 3.

Second Property. While the viscosity of natural gas is temperature dependent, the effective viscosity μ* is remarkably temperature insensitive, corresponding to about 0.1% K⁻¹ around 300K, as follows from FIG. 3. A similar temperature-independence is found for the effective thermal conductivity of methane, the primary component of natural gas.

Third Property. As outlined in the introduction, the Wobbe-index W describes the interchangeability in injector power appliances. FIG. 4 shows that the Wobbe-index is correlated with the reciprocal of the effective thermal conductivity within 5%.

According to the 1^{st} and 2^{nd} Property, sensitivity in the effective viscosity (5) to natural gas-composition is primarily due to varying concentrations of nitrogen, i.e., about 0.6% per percent nitrogen concentration. This result is very similar to that for the microcopic viscosity μ, calculated by the Herning-Zepperer method (e.g. Metz, Aretz & Wilhelmi 2004). Properties 1-2 allow us to view natural gas to leading order as a binary mixture of methane and nitrogen—an approximation which holds well between the L-type Gronings natural gas and the H-type US average. As a result, the effective viscosity and thermal conductivity (5) are tightly correlated, in response to their variations with nitrogen concentration. We find that

μ*×λ*^{1.8}≃C₁ (6)

holds to a good approximation around 300K, where C₁ denotes a constant. Discrepancies in (6) as a function of temperature are about 0.1% K⁻¹, well in the intended range of accuracy. According to the 3^{rd} Property, we have for the Wobbe index

W×λ*≃C₂, (7)

where C₂ denotes a constant of proportionality. Discrepancies in (7) are about 5% across species, as shown in FIG. 3. For ten percent changes in, e.g., methane concentration, this would entail an uncertainty of 0.5%. Therefore, (7) enables accurate monitoring of changes or trends in the Wobbe-index.

### SURVEY OF THE DRAWINGS

FIG. 1. Shown is the Nusselt-response curve (up to a constant of proportionality) as a function of the effective Reynolds number in the measurement chamber. The measurement chamber mediates a small fraction of about 0.1% of the main flow using a by-pass configuration. The Grashof index p=1/8 in the effective viscosity μ*=Gr^{P}μ is determined experimentally by matching the response curves to different calibration fluids argon, carbon dioxide, nitrogen, and helium. A slight departure is observed in CO₂, in particular at low flows, which we attribute to its relatively high Grashof number. Possibly, the CO₂-curve also reflects non-Boussinesq effects, associated with a high melting point of 217K and commensurate large logarithmic derivative κ=T/Pr∂Pr/∂T=0.14 (at 300K). However, at about concentration levels of about 1% in natural gas (but not biogas), it falls outside the scope of the present application. Thermodynamic anemometry measures thus mass-flow by inverting the Nusselt-response curve to effective Reynolds number.

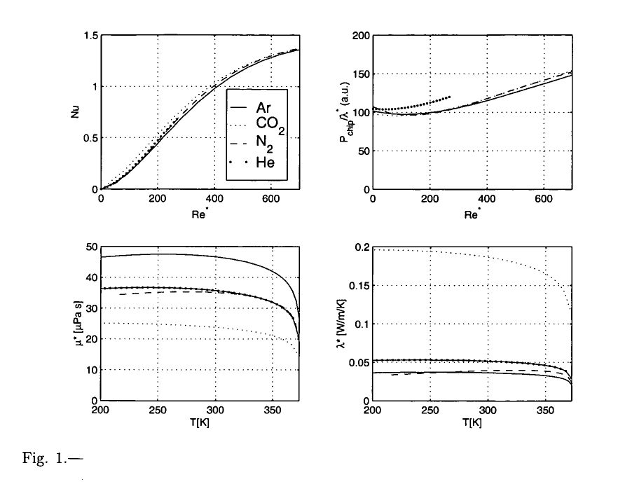

FIG. 2. The Nusselt-response curve is remarkably insensitive to temperature variations, here shown for helium with measurements at room temperature (26.7 degrees Celsius) and below zero (−7.9 degrees Celsius). Notice a small deviation at higher flow-rates, which we attribute to the limited heat-exchange in our experimental set-up. For the low-temperature experiment, a computer controlled mass-flow is applied to the device, positioned inside a freezer. One low-temperature 50 cm long copper pipe serves as a heat-exchanger, to extract heat from the fluid before it enters the device, and a long closed-loop duct serves to add heat back into the fluid upon exit for volumetric measurement in an Instromet rotary reference meter at room temperature. This experiment works well for helium, in view of its small thermal time-constant τ[He]=0.63 s (L/cm) for a cube of linear size L, but considerably less so for the other calibration gases. Indeed, the thermal time-constants of the latter are are an order of magnitude larger, i.e., τ[Ar]=4.2, τ[CO₂]=11.6 and τ[N₂]=5.4 in units of s (L/cm). The observed small temperature sensitivity in the Nusselt response curve agrees well with the sensitivity of about 0.1% K⁻¹ around 300 K of the effective viscosity μ*. As a result, thermodynamic anemometry measures mass-flow with intrinsically negligible dependence on medium temperature.

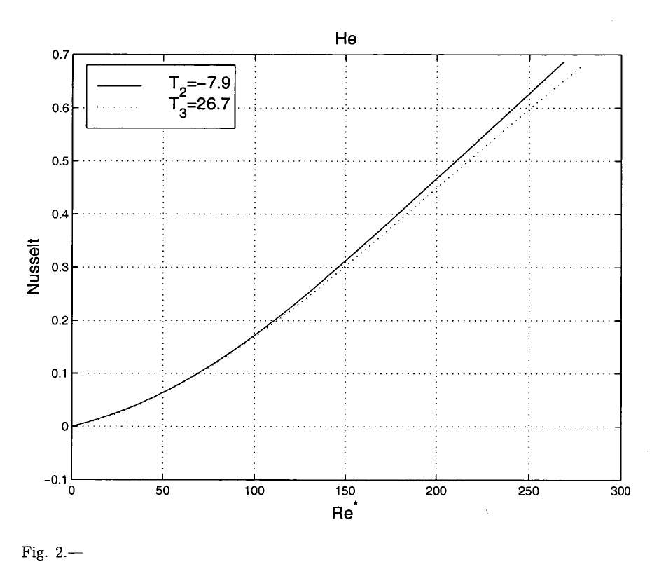

FIG. 3. (Top) Shown is the product of the effective viscosity λ* with the Wobbe-index for some common fuels. The product is remarkably constant across species with a relative variation around of the mean of 5%. Shown are also the effective viscosities μ*. (Bottom Left) The effective viscosities of these common fuels are remarkably similar, even when the intrinsic viscosities (μ[methane]=10.2, μ[ethana]=8.5 and μ[propane]=7.6 in units of μPa s) are not, and are remarkably insensitive to temperature variations, i.e., about 0.1% K⁻¹ around 300K. To leading order, natural gas comprises a binary mixture of methane and nitrogen with respective concentration levels 81.30% and 14.35% in the L-type Gronings natural gas and 92.3% and 1.8% in the H-type US average. It contains subdominant concentrations of ethane (2.85% in Gronings, 3.6% in US average), CO₂ (0.89% in Gronings, 1.0% in US average), and smaller concentrations of higher hydrocarbon compounds. As demonstrated in FIG. 1, thermodynamic anemometry introduces gas-sensitivities effectively via the effective viscosity. For a largely binary mixture of nitrogen and the sum of all hydrocarbon compounds, the effective viscosity of natural gas depends only on the nitrogen concentration. As a result, sensitivity to gas-composition is parametrized only by the nitrogen concentration. (Bottom Center) Shown is the effective thermal conductivity λ* for common fuels. (Bottom Right) The product μ*×λ*^{1.8} for a methane-nitrogen mixture is constant to within a temperature dependence of about 0.1% K⁻¹. By this correlation, λ* provides a measurement of μ*, allowing for corrections in mass-flow with respect to varying nitrogen concentration levels in natural gas.

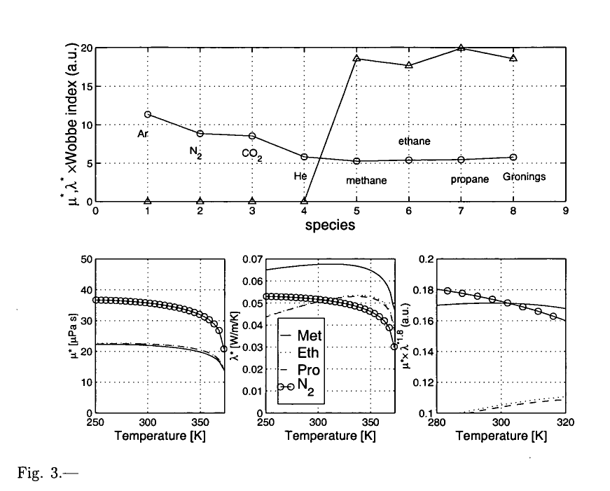

### PREFERRED EMBODIMENTS

The preferred embodiments comprise a number of issues for optimal performance, manufacturing, safety, accuracy and durability.

The preferred method for measuring the effective viscosity λ* is during no-flow conditions. No-flow conditions occur naturally in domestic gas-energy usage, and can also be introduced as brief moments of quiescence in between the reversal of flow-orientation in the Alternating Direction Method. Furthermore, λ* can be most easily determined, by exploiting diurnal temperature variations in the metering process. As a result, λ* can be determined by correlating the variations in the total dissipation with these temperature variations, especially when operating the sensor chip at constant temperature. Such correlation process obviates the need for information on the sensor temperature itself.

The preferred physical embodiment follows current trends in small, smart and easy-to-use, while paying attention to safety, reliability, data-integrity and battery-free operation to facilitate decade-long observations. For safe battery-free operation, the unit is powered by a standard outside adapter, connected to the wall or main electrical power cable. It is preferrably made entirely of aluminum for durability and safety.

The preferred mode of operation of the sensor is at an appreciable Rayleigh number to introduce the desired temperature insensitivity of the induced effective viscosity. It can be made in the form of a small silicon chip, which provides heating and contains an integrated Wheatstone bridge for in-situ measurement of temperature gradients. The preferred embodiment of the silicon chip is a flow-sensor with parallel topology of the resistive Wheatstonebridge elements at the edges. The micro-chamber is exposed to an external flow which enters the chamber at the edges of the silicon chip for maximal sensitivity, while subject to modulation according to the Alternating Direction Method. A preferred safety test is a leak-test at 5 bar helium.

The preferred energy-data include high-resolution real-time mass-flow, total normal volume used and the Wobbe-index. Combined with a wireless link to a local weather station, the preferred energy-weather data include at least the outside temperature.

The total system preferrably is made in four physically separate units, which are wirelessly integrated into one energy-weather measurement, data-analysis and climate control system. These four units are the gas-energy observatory, comprising a small meter and a battery-free solar-powered weather station, a remote display for visual feedback to the user and a home-climate system. Here, the remote display may be located at a convenient location in the home such as a kitchen. A preferred wireless communication system is a commercially available multi-channel system such as Bluetooth, which further allows for encryption for privacy ensurance. The preferred total system performs data-archiving, enabling long-term monitoring of the performance, i.e., human behavior, home quality, and long-term climate monitoring.

The preferred energy-saving home-climate algorithms include correlations to the outside weather (van Putten et al. 2006) and correlations directly to the human body temperature, as governed by the human biological clock. In practice, the results of such two correlation algorithms can be very similar, as the human biological clock is, by nature, tightly coupled to the daily variation in outside temperature—with the noticeable exception in case of jet-lag in long-distance travels.

These preferred embodiments presented here serve to illustrate the main concepts towards energy savings in new and existing homes (and businesses). In practice, variations in the details are possible, while remaining within the general frame-work set forth in the following claims.

### SUMMARY

Modern technology in measurement and computation can provide the tools for powerful energy saving strategies based on high-resolution feedback to the consumer, interactive features with advanced visual data-presentation and wireless interfacing. Here, we disclose a concept for a gas energy observatory, which serves customers, gas-suppliers and climate researchers. The observatory uses a new physical measurement principle, which extracts both mass-flow and the Wobbe-index from a single silicon silicon integrated flow-sensor. The energy data it produces serves the customer by creating a complete picture in gas-energy usage based on high-resolution gas-flow measurements with in-depth weather sensitivity analysis. These energy-weather data provide feedback and can be used for energy-saving home-climate systems and home energy audits. Novel energy-saving home-climate algorithms will use a combination of correlations to weather and the human biological clock. The energy data serve the gas-supplier by presenting total normal volume, peak-flow measurement and locally measured Wobbe-index for detailed billing. At no additional cost, the weather data can be gathered the purpose of creating a wide-area climate observation system.

### A Gas-Energy Observatory with Wobbe-Index

Inventor: Mauritius H. P. M. van Putten
Address: 266 Pearl Street A, Cambridge, Mass. 02139, USA
Citizenship: U.S.A.
Inventor: Antonius F. P. van Putten
Address: Gulbergsven 4, 5645 KK Eindhoven, The Netherlands
Citizenship: The Netherlands
Inventor: Michael J. A. M. van Putten
Address: Beukinkstraat 120, 7511RR, Enschede, The Netherlands
Citizenship: The Netherlands
Inventor: Pascal F. A. M. van Putten
Address: Ruys de Berenbrouckstraat 20, 2513 AT, Delft, The Netherlands
Citizenship: The Netherlands

### REFERENCES

1. Bodenschatz, E., de Bruyn, J. R., Ahlers, G., & Cannell, D. S., 1991, Phys. Rev. Lett., 67, 3078
2. Busse, F. H., 1967, J. Fluid Mech., 30, 625
3. Boussinesq, J., 1897, Théorie de l'écoulement tourbillonnant et tumultueux des liquides dans les lits rectilignes à grandes section (Paris: Gauthier-Villars)
4. Chandrasekhar, S., 1961 Hydrodynamics and Hydromagnetic Stability, Oxford University Press (London)
5. Department of Energy, 2006, Carbon Dioxide Emissions, 2006, http://www.eia.doe.gov/oiaf/1605/gg04rpt/carbon.html
6. Foss, M. M., 2004, Interstate Natural Gas-Quality and Interchangeability (Center for Energy Economics)
7. King, L., 1914, Proc. Roy. Soc. London A, 90, 563
8. Liss, W. E., & Rue, D. M., 2005, Natural Gas Composition and Quality (Gas Technology Institute)
9. Marcogas, 2002, National Situations Regarding Gas Quality
10. Metz, S. W., Aretz, W., & Wilhelmi, H., 2004, Chem. Eng. & Techn., 18, 386
11. National Academy of Sciences, 1999, “Adequacy of climate observing systems”
12. National Academy of Sciences, 2001, “Climate change science: an analysis of some key questions”
13. National Academy of Sciences, 2006, “Surface Temperature Reconstructions for the last 2000 years”
14. Nederlandse GasUnie N. V., 1988, Physical Properties of Natural Gases (T. M. Geerssen, editor)
15. For physical properties of fluids, see, e.g., the online NIST database (http://www.nist.gov)
16. Physical Properties of Natural Gases, 1990, Nederlandse Gasunie N. V., edited by Theo M. Geerssen
17. Rayleigh, L., 1916, Phil. Mag., 32, 529
18. van Putten, A. F. P., & Middelhoek, S., 1974, Electron. Lett., 10, 425
19. van Putten, A. F. P., 1975, Device for measuring the flow velocity of a medium, U.S. Pat. No. 3,996,799
20. van Putten, A. F. P., 1985, Ambient temperature compensated double bridge anemomenter, U.S. Pat. No. 4,548,077
21. van Putten, M. J. A. M., van Putten, M. H. P. M., & van Putten, A. F. P., 1994, Sensors & Actuators, 44, 13
22. van Putten, M. H. P. M., van Putten, M. J. A. M., van Putten, A. F. P., & van Putten, P. F. A. M., 1995, U.S. Pat. No. 5,426,969
23. van Putten, A. F. P., van Putten, M. J. A. M., & van Putten, M. H. P. M., 1996, Measurement Science and Technology, 7, 1360
24. van Putten, M. J. A. M., van Putten, M. H. P. M., van Putten, A. F. P., Pompe, J. C., Bruining, H. A., 1997, IEEE T. Biomed. Eng., 44, 205
25. van Putten, M. J. A. M., van Putten, M. H. P. M., & van Putten, A. F. P. van Putten, 1999, IEEE T Instruments and Measurements, 48, 724
26. van Putten, M. J. A. M., & van Putten, M. H. P. M., 2001, Sensors and Actuators, 90, 172
27. van Putten, M. H. P. M., van Putten, M. J. A. M., van Putten, A. F. P., & van Putten, P. F. A. M., 2002, EU Patent 94202293.0
28. van Putten, M. H. P. M., van Putten, M. J. A. M., van Putten, A. F. P., & van Putten, P. F. A. M., 2006, U.S. patent application Ser. No. 11/337,950
29. van Putten, M. H. P. M., van Putten, M. J. A. M., van Putten, A. F. P., & van Putten, P. F. A. M., 2006, U.S. patent application Ser. No. 11/495,703

We claim:

1. A method for measuring mass-flow in natural gas-metering using a silicon integrated flow-sensor embedded in a micro-chamber of generally small dimensions with the property that an external flow is passed through said micro-chamber, where said micro-chamber contains a silicon flow-sensor heated to an elevated temperature producing two output signals, where one signal represents total heat dissipated in said sensor, where said heating induces buoyancy-convection for enhancement of the physical transport coefficents of momentum and heat in the bulk flow of the micro-chamber described by an effective viscosity (μ*) and an effective heat conductivity (λ*), and where the other signal is a Nusselt number (Nu) expressing the response to the effective Reynolds number (Re*) defined by mass-flow through said micro-chamber relative to said μ*.

2. A method for measuring mass-flow according to claim 1 with the property that said enhancement is governed by an amplification factor given by the Grashof number raised to a fractional power, where said fractional power is determined by invariance of the Nusselt-response curves versus the effective Reynolds number of said mass-flow with repect to temperature variations.

3. A method for measuring mass-flow according to claim 1 with the property that said enhancement is governed by an amplification factor given by the Grashof number raised to a fractional power, where said fractional power is determined by invariance of the Nusselt-response curves versus the effective Reynolds number of said mass-flow with repect to different calibration fluids.

4. A method for measuring mass-flow according to claim 1 with the property that the physical correlation between λ* and μ* is used to estimate μ* in the presence of variations in gas-composition, where said estimate is used to calculate mass-flow from the effective Reynolds number Re*, where Re* is determined from said output signal Nu.

5. A method for measuring mass-flow according to claim 1 with the property that the physical correlation between λ* and μ* is used to estimate the Wobbe index, where said Wobbe-index is used to monitor the interchangeability of natural gas in the presence of variations in gas-compositions.

6. A method for measuring mass-flow according to claim 1 with the property that two output signals are extracted from said sensor upon passing an external flow through said micro-chamber, where said external flow is modulated according to the Alternating Direction Method comprising the periodic reversal of said flow passing through said micro-chamber, wherein brief moments of no-flow in the micro-chamber are used to measure λ* on the basis of the total heat dissipation in said silicon chip.

7. A method for measuring mass-flow according to claim 1 with the property that λ* is measured on the basis of correlations between the natural variations in ambient temperature and the total heat dissipation in the chip under no-flow conditions.

8. A method for monitoring the Wobbe index according to claim 5 with the property that said Wobbe index is used for automatic tuning of gas-appliances, where said automatic tuning is aimed at optimal burning in the presence of variations in gas-composition.

9. A method for observing and analyzing domestic gas-energy usage using thermodynamic anemometry, where said method serves to provide energy data to multiple parties comprising customer, gas-supplier and government, where said energy data represent the complete picture in gas-energy usage related to local weather to said consumer, where said energy data represent normal volume used, peak-flows and locally measured Wobbe-index to said gas-supplier, and where said energy data represent weather information to said government for integration into a wide-area high-resolution climate observation system.

10. A method for energy-saving home-climate control with the property that the inside temperature is correlated to the natural temperature variations in the human body defined by the human biological clock, where the strength of said correlation is fine-tuned by the user for a balance between optimal comfort and cost-savings in heating, where said cost-savings are validated by feedback in the form of gas-energy information provided by measuring gas-energy usage.
